(19) United States
(12) Patent Application Publication
(10) Pub. No.: US 2005/0145270 A1
(43) Pub. Date: Jul. 7, 2005

(54) Pressure washer with injector

(76) Inventor: R. Kevin Ray, Gallatin, TN (US)

Correspondence Address: Lorri W. Cooper;JONES DAY, 901 Lakeside Avenue, Cleveland, OH, 44114, US

(21) Appl. No.: 10/749,415

(22) Filed: Dec. 31, 2003

(51) Int. Cl. B08B 3/00

(52) U.S. Cl. 134/174; 239/124; 239/532

(57) ABSTRACT

A pressure washer includes a pump and an injector. The pump is configured to pump a fluid at a pressure that ranges from low to high. The injector has a nozzle and an external member, with the external member being positioned around the nozzle. The injector is configured to spray at least one of a fluid or a fluid combined with a first chemical in the low pressure range, and at least one of a fluid or a fluid combined with a second chemical in the high pressure range. An injector is provided that includes a metallic nozzle and a non-metallic external member.

### FIELD OF THE INVENTION

The claimed invention relates to a pressure washer that is configured to spray soap at both a high and a low pressure. The pressure washer includes a spray lance and an injector and a chemical tank is attached to the spray lance. The tank is operable in both an upright and an inverted position. The injector includes a metallic nozzle and a plastic aspirator.

### BACKGROUND OF THE INVENTION

A pressure washer is a device that includes a pump, a hose, and a spray lance having an injector. A fluid source, such as water, is connected to the pump and fluid is pumped through the hose and out the injector for application to a surface. It is often desirable in pressure washer applications to utilize a chemical, such as detergent, to clean a surface. Surfaces that are typically treated with a pressure washer may be at ground level or higher. It is not uncommon for a pressure washer to be used to spray a multi-story building, such as a three story house, or a single level structure, such as a deck or porch.

Typical pressure washers spray soap at either a low pressure or a high pressure. A user will typically use low pressure spray to reach easy to reach areas and high pressure spray to reach hard to reach areas, such as the second story of a home or office building. With existing low pressure soap sprayers, soap can be applied to the first story of a house, but not to higher stories. In order to reach higher stories, it is necessary to use a ladder in conjunction with the spray lance, while the pump and soap container remains on the ground. With existing high pressure soap sprayers, soap can be applied to the upper stories of a house, but not at lower stories because the high pressure of the sprayer may result in damage to the facade of the house. High pressure applicators can be used on lower stories only if the user backs a far enough distance away from the structure, in order to avoid damaging the facade.

Pressure washers and other sprayers utilize a venturi effect to suction a chemical into a flow stream. Venturis are well known for introducing a second fluid into a first fluid. The second fluid is introduced through an aspirator inlet that is typically aligned with a narrowed portion of the venturi, or positioned downstream of the venturi. In operation, the second fluid to be introduced is sucked into the venturi through the aspirator inlet as fluid flows through the venturi tube. For a given venturi tube, the aspiration rate depends on the flow rate of the fluid which passes through the venturi inlet and the viscosity of the fluids.

### SUMMARY

According to one embodiment of the invention, a pressure washer includes a pump and an injector coupled to the pump. The pump has a fluid inlet for a fluid and a first chemical inlet for a first chemical. The pump is configured to selectively pump a fluid at a pressure that ranges from low to high, and to selectively pump a fluid combined with a first chemical in a low pressure range. The injector has a nozzle and an external member. The nozzle has an internal passageway and an external passageway. The external member is positioned at least in part around the nozzle and the external passageway. The external member has a second chemical inlet positioned downstream from the nozzle for supplying a second chemical into a fluid. The injector is configured to spray at least one of a fluid or a fluid and a first chemical in the low pressure range, and at least one of a fluid or a fluid and a second chemical in the high pressure range.

In another embodiment, a pressure washer includes a pump for pumping a fluid at at least a low pressure and a high pressure, an injector coupled to the pump that has a restrictive nozzle for spraying the fluid, and at least one chemical source for injecting a chemical into the fluid. The pressure washer has at least thee modes of operation, including a first mode comprising a low pressure spray of the fluid combined with the chemical, a second mode comprising a high pressure spray of the fluid, and a third mode comprising a high pressure spray of the fluid combined with the chemical. The fluid flows through the nozzle in the second and third modes. The fluid combined with the chemical flows through and around the nozzle in the first mode.

In yet another embodiment, a pressure washer injector includes a metallic nozzle and a non-metallic external member. The nozzle has an axially extending internal passageway that includes a flow restricting portion. The nozzle is for receiving a fluid under pressure from a pressure washer. The external member is positioned around at least part of the nozzle and includes a chemical inlet. A venturi is positioned in the external member upstream from the chemical inlet.

In a further embodiment, an injector includes a metallic nozzle and a non-metallic external member. The nozzle has an axially extending internal passageway, with the internal passageway including a flow restricting portion. The external member is movably disposed around at least part of the nozzle and includes a chemical inlet positioned downstream from the nozzle.

### BRIEF DESCRIPTION OF THE DRAWING FIGURES

FIG. 1 is a view of a pressure washer according to the invention;

FIG. 2 is partial view of the pump and first chemical inlet of the pressure washer;

FIG. 3 is a partial view of the pump showing the first chemical inlet in greater detail;

FIG. 4 is a perspective view of the spray lance and injector according to the invention incorporating a chemical tank attached to the spray lance;

FIG. 5 is a perspective view of the chemical tank shown in FIG. 4;

FIG. 6 is an end view of the chemical tank of FIG. 5;

FIG. 7 is a top view of the spray lance and injector according to the invention;

FIG. 8 is a side view of the spray lance and injector of FIG. 6;

FIG. 9 is a bottom view of the spray lance and injector of FIG. 6;

FIG. 10 is a cross-sectional view of the cover of the injector shown in FIG. 6;

FIG. 11 is an end view of the cover shown in FIG. 9;

FIG. 12 is a cross-sectional view of injector body of the injector shown in FIG. 6;

FIG. 13 is a partial top view of the injector shown in FIG. 6;

FIG. 14 is a partial bottom view of the injector shown in FIG. 6;

FIG. 15 is a cross-sectional view of the injector shown in FIG. 6 in a high pressure spray mode;

FIG. 16 is a cross-sectional view of the injector of FIG. 15, but in a low pressure spray mode;

FIG. 17 is a cross-sectional view of the cap assembly according to the invention;

FIG. 18 is a perspective bottom view of the outer cap member of the cap assembly shown in FIG. 17;

FIG. 19 is a perspective top view of the outer cap member of FIG. 18;

FIG. 20 is a cross-sectional view of the outer cap member shown in FIG. 19, taken along line 20-20;

FIG. 21 is a perspective top view of the inner cap member of the cap assembly shown in FIG. 17;

FIG. 22 is a perspective bottom view of the inner cap member of FIG. 21;

FIG. 23 is a top view of the inner cap member shown in FIG. 21;

FIG. 24 is a cross-sectional view of the inner cap member of FIG. 23, taken along line 24-24;

FIG. 25 is a partial perspective view of the cap assembly installed on the chemical tank; and

FIG. 26 is an exploded view of the locking mechanism for the cap assembly.

### DETAILED DESCRIPTION OF THE INVENTION

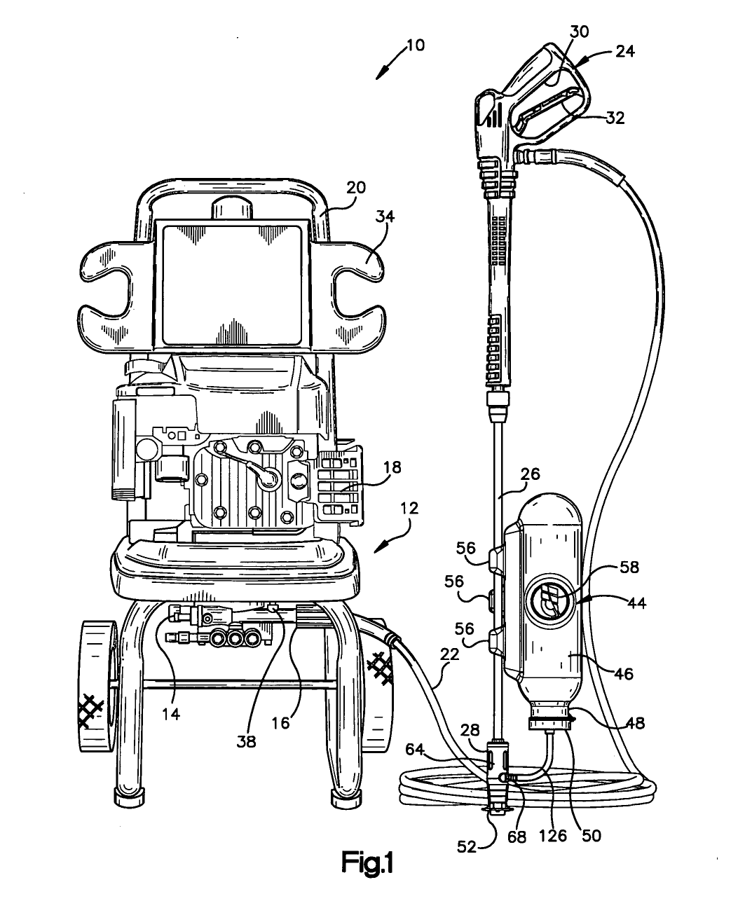

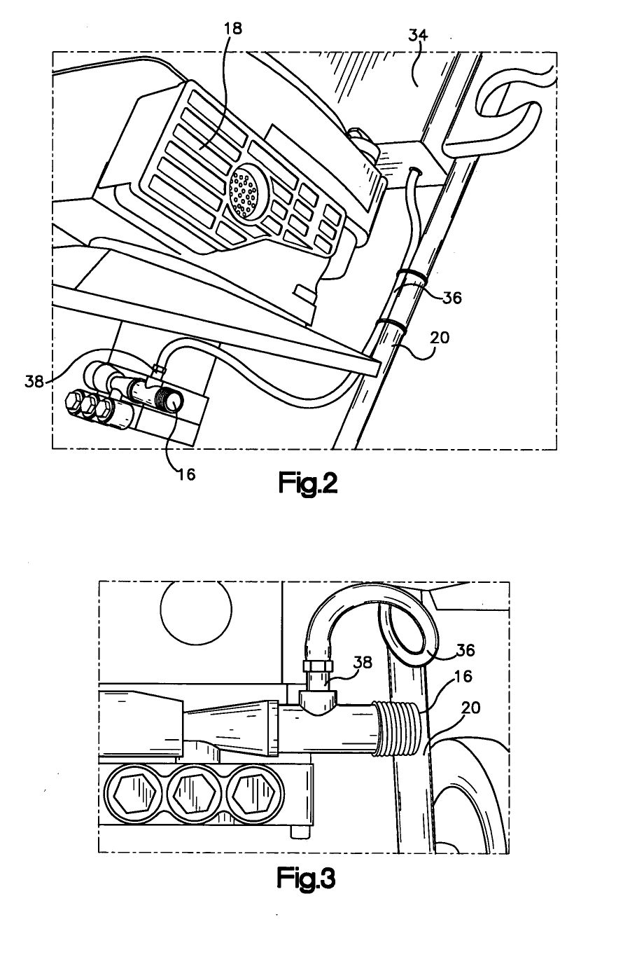

FIG. 1 shows a pressure washer 10 according to the invention and FIGS. 2-3 show several exploded views of the pressure washer 10 of FIG. 1. The pressure washer 10 includes a pump 12 for pumping a fluid from a fluid source (not shown). The pump 12 includes an inlet 14 for receiving a fluid from the fluid source and an outlet 16 for pumping the fluid at a pressure. The pump 12 is operated by a motor 18, which may be powered by gas, electric, or another energy source. The pump 12 and motor 18 are preferably positioned on a support structure 20, such as the cart shown, so that they may be easily maneuvered around a job site. A hose 22 is connected to an outlet 16 of the pump 12 and a spray gun 24, a spray lance 26, and an injector 28 are connected to the hose 22 for spraying a fluid that is received under pressure from the pump 12. The spray gun 24 includes a handle 30 and a trigger 32 for opening the spray lance 26 to receive fluid from the pump 12. The operator pulls the trigger 32 in order to open flow of a fluid from the pump 12.

The pressure washer 10 is configured to spray a fluid out of the injector 28 at a pressure range that ranges from a low pressure to a high pressure. In a preferred embodiment, the pressure washer 10 is configured to spray at a low pressure range of about 25 to about 200 psi and at a high pressure range of about 500 to about 3200 psi.

A first chemical tank 34 is positioned on the cart 20 and includes a conduit or tube 36, shown best in FIG. 2, that extends from the first chemical tank 34 to a first chemical inlet 38 of the pump 12, shown best in FIG. 3. The first chemical tank 34 is preferably made of a non-corrosive plastic material and is utilized for storing chemicals, such as detergent, among other chemical substances. In one embodiment, the first chemical tank 34 is made of a thermoplastic material, such as high density polyethylene. Other types of impact resistant, non-corrosive materials may also be used for the tank. The first chemical tank 34 is provided in order to introduce a first chemical into the fluid. When the first chemical is introduced into the fluid, the fluid combined with the first chemical travels through the hose 22 to the spray lance 26 and is sprayed onto a surface through the injector 28.

The pump 12 includes a venturi (not shown) that is positioned in the fluid line in alignment with the first chemical inlet 38. Venturis are well known in the art for introducing a second fluid into a first fluid. The venturi is utilized to create a vacuum in the vicinity of the venturi and this vacuum serves to suction the first chemical from the first chemical tank 34 into the fluid. Venturis typically have an aspiration rate that is dependent upon the flow rate of the fluid that flows through the venturi tube. The pump venturi is designed to suction a first chemical when the pump 12 is operating in the low pressure spray range, described above. Thus, the pump 12 is configured to pump either a fluid from the fluid source, or a combination of the fluid from the fluid source combined with a first chemical from the first chemical tank 34.

A valve may be positioned between the first chemical tank 34 and the first chemical inlet 38 for opening and closing the flow of the first chemical from the tank. Thus, in order to allow the first chemical to flow, the operator must open the valve between the first chemical tank 34 and the first chemical inlet 38.

The pressure washer 10 also utilizes a second chemical tank 44, shown in FIGS. 1 and 4-6. The second chemical tank 44 is utilized to spray a second chemical, which may be the same as or different from the first chemical. The second chemical tank 44 is preferably made of a non-corrosive plastic material and is utilized for storing chemicals, such as bleach or detergent, among other chemical substances. In one embodiment, the second chemical tank 44 is made of a thermoplastic material, such as high density polyethylene. Other types of impact resistant, non-corrosive materials may also be used for the second chemical tank 44.

The second chemical tank 44 is preferably an elongated, tube-shaped, hollow container 46 that has an opening 48 at one end. The opening 48 is closed by a cap assembly 50, which will be described in greater detail below. The second chemical tank 44 is provided in order to introduce a second chemical into the fluid as the fluid travels through the injector 28. When the second chemical is introduced into the fluid, the fluid combined with the second chemical is sprayed through the exit 52 of the injector 28.

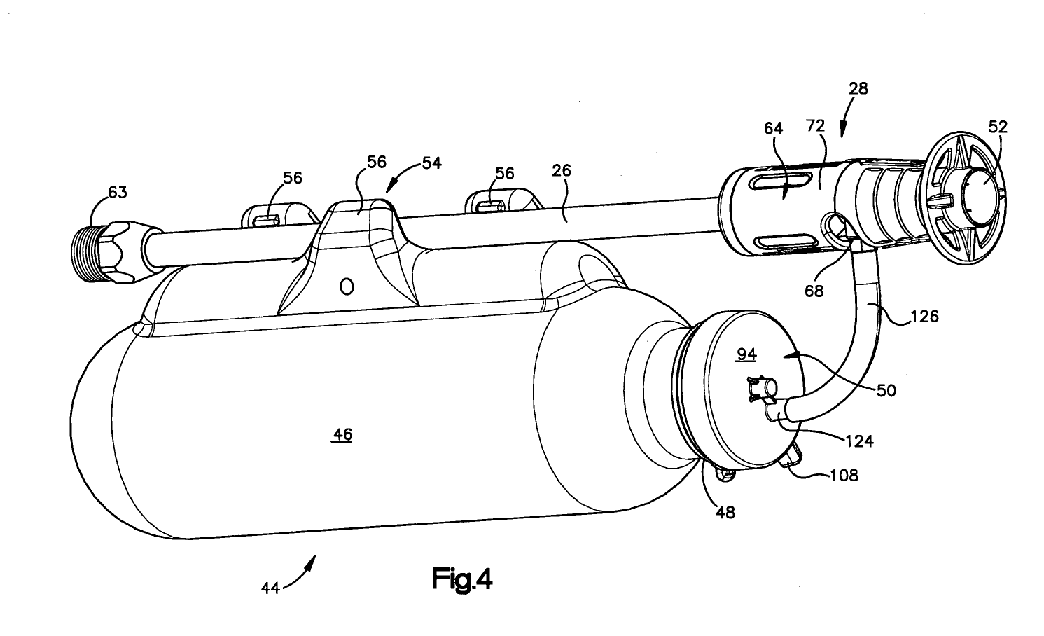

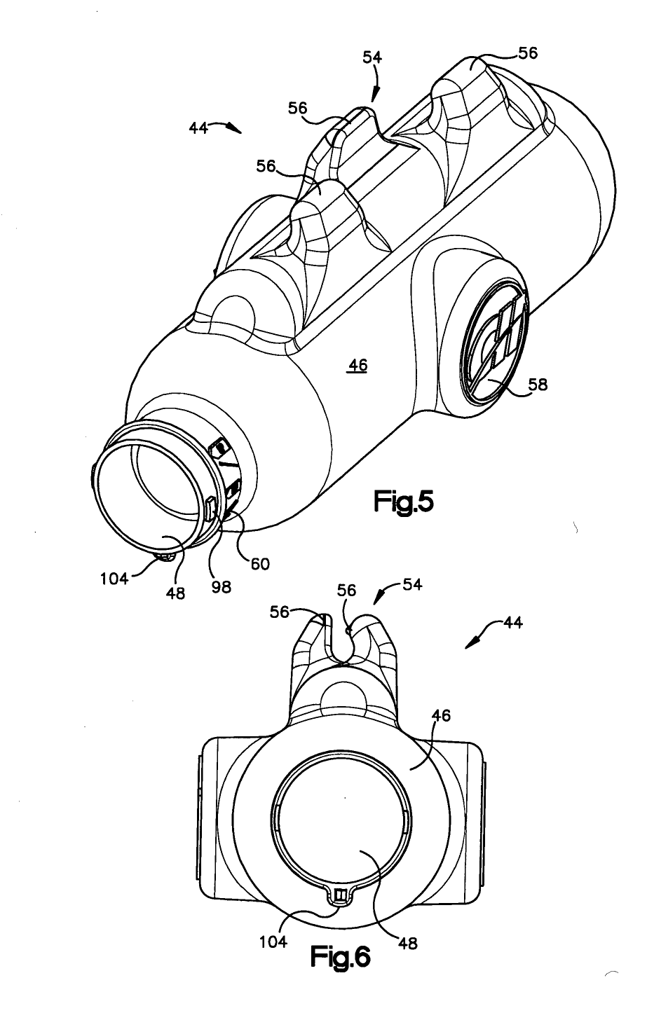

As shown in FIG. 4, the container 46 includes an attachment mechanism 54. In the embodiment shown, the attachment mechanism 54 includes three clips 56 that are positioned in alignment on one side of the container 46. The clips 56 are configured so that a first and a second clip 56 face a third clip 56 and such that the three clips together snap on and firmly engage a spray lance 26. As shown, the spray lance 26 is an elongated tube, which may be made of steel or another rigid material. The clips 56 have a cross-section, shown in FIG. 6, such that they firmly grip the elongated tube of the spray lance 26. The clips 56 each may have the same cross-section, but with the middle clip being a mirror image of the end clips. Alternatively, the clips 56 may have different cross-sections. In a preferred embodiment, shown in FIG. 6, the middle clip has a different cross-section than the end clips in order to allow ease in attaching the container 46 to the spray lance 26. The clips 56 are configured so that the container 46 is immovable relative to the lance 26 and integral with the lance 26 when the container 46 is clipped to the lance 26. When the user moves the lance 26, the container 46 moves with the lance.

The container 46 may have any desired length. As shown in FIG. 1, the container 46 may have a length that is less than the length of the spray lance 26, or may have a length, as shown in FIG. 4, that exceeds the length of the lance. The attachment mechanism 54 is designed so that the container 46 may be removed from or replaced onto the spray lance 26, when desired. Other forms of the attachment mechanism may alternatively be used, such as other clip or snap-on designs, or designs that utilize screws, clamps or bolts, among other designs. Alternatively, other attachment mechanisms may be utilized to connect the container 46 at other points on the spray gun 24. A stand alone tank (not shown) that sits on the ground may be used, if desired, as long as a conduit or hose extends from the tank to the injector 28 to allow the suctioning of the second chemical into the fluid. A container 46 that is attached to the spray lance 26 is preferred and desirable because it allows for portability of the unit and does not require the user to lug around an additional hose. In a preferred embodiment, the container 46 holds ½ gallon of chemical. Other shapes and sizes of container 46 may also be utilized, the invention not being limited to the shape and size of container 46 shown.

The container 46 may include advertising indicia 58, if so desired. In addition, operating instructions 60 may be positioned on the tank for assisting the operator in using the container 46 or the cap assembly 50.

In one embodiment, the pressure washer 10 has three operative modes. The first mode includes low pressure spray of fluid combined with the first chemical. The second mode include high pressure spray of fluid without chemical and the third mode includes high pressure spray of the fluid combined with the second chemical. In a second embodiment, the pressure washer has four operative modes that include the first, second and third modes and an additional fourth mode. The fourth mode includes low pressure spray of the fluid without the first chemical.

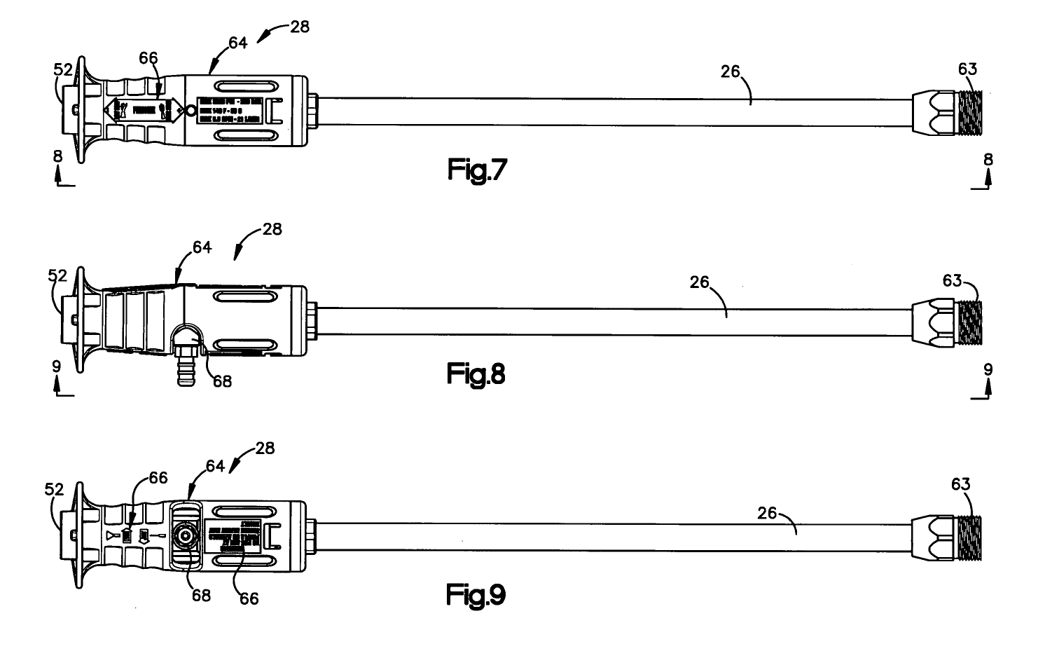

The injector 28 and spray lance 26 are shown in FIGS. 7-16 in various orientations. The spray lance 26 is attached to the injector 28 in a conventional manner, such as with screw threads 62. The spray lance 26 is connected to the spray gun 24, at the other end, utilizing screw threads 63 or other attachment mechanisms known to those of skill in the art. It is preferred that the injector 28 have a movable external member 64 that can move axially as well as rotationally. FIGS. 7 and 13 show a top view of the injector 28 and operational indicia 66 that may be included on the injector 28. In this view, the user is prompted to vary the flow from high to low pressure by moving the external member 64 forward or rearward. In the forward position, the injector 28 will introduce flow at a low pressure while in the rearward position, the injector 28 will introduce flow at a high pressure. FIG. 8 shows a side view of the injector 28, showing the second chemical inlet 68 to the injector 28. FIGS. 9 and 14 show a bottom view of the injector 28, with instructions 66 on how to vary the spray pattern of flow coming from the injector 28 by rotating the external member 64. The user rotates the injector 28 clockwise to emit a fan-like spray pattern and the user rotates the injector 28 counter clockwise to emit a stream of fluid. Various positions between the two extremes of a fan and a stream are provided by rotating the external member 64 a partial turn. Other types of spray patterns may also be provided in addition to or instead of the described spray patterns.

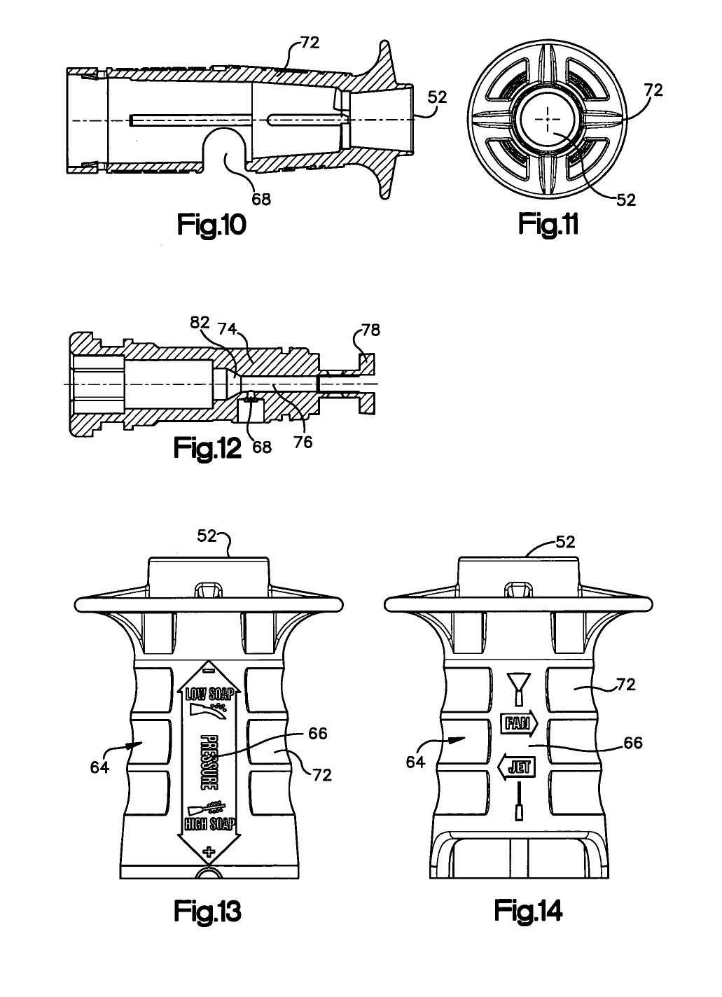

As shown in FIGS. 10-12 and 15-16, the injector 28 includes an external member 64 and a nozzle 70. The external member 64 includes a cover 72 and an injector body 74. The injector body 74 extends inside of the cover 72 and includes the second chemical inlet 68 and the venturi 82. The cover 72 and injector body 74 are positioned adjacent one another and are axially movable relative to the nozzle 70. Axial movement of the external member 64 allows the user to alter the pressure of the fluid being discharged from the injector 28 between a low pressure and a high pressure. FIG. 13 shows indicia 66 on the outer surface of the cover 72 that describes the position of the cover 72 in order to obtain low and high pressure spray. The cover 72 is also rotatable relative to the injector body 74 to change the spray pattern. As shown in FIG. 14, the cover 72 includes indicia 66 on an outer surface that describes the position of the cover 72 in order to alter the spray pattern from a fan to a jet.

The injector body 74 includes an internal passageway 76 in which the nozzle 70 seats and fluid flows. The venturi 82 is defined in the internal passageway 76. In addition, the injector body 74 may include spray arms 78. The spray arms may be formed integral with the injector body, or may be formed as separate flow directing members. A spray deflecting member 79 may be seated inside the spray arms 78 and extends longitudinally toward the injector outlet 52. When the cover 72 is rotated, the spray arms 78 or spray deflecting members 79 move against surfaces defined on the interior of the cover 72 in order to deflect the spray deflecting member 79 to provide the desired spray pattern from the injector 28.

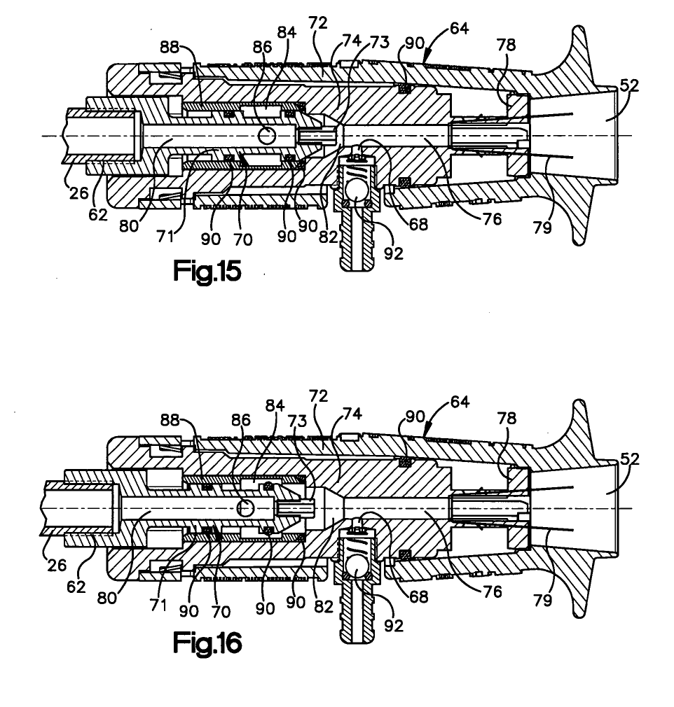

As shown in FIGS. 15 and 16, the nozzle 70 is positioned inside the injector body 74 and includes a longitudinal internal passageway 80 that aligns with the internal passageway 76 of the injector body 74. The nozzle 70 is shown as including two parts: 1) a nozzle body 71 and 2) a nozzle tip 73. The nozzle tip 73 may be screwed into the nozzle body 71, or otherwise connected to the nozzle body 71. Alternatively, the nozzle tip 73 can be integrally formed with the nozzle body 71 so that they together are formed as a single piece. The nozzle tip 73 includes a flow restricting portion for restricting the flow through the nozzle 70. The nozzle 70 also includes an external passageway 84 that travels around the nozzle 70 through a hole 86 that is positioned in the internal passageway 80 of the nozzle 70. The hole 86 in the nozzle 70 allows fluid to travel from the internal passageway 80 to the external passageway 84 around the side and front of the nozzle 70. The fluid flows around the nozzle 70 and then joins with fluid that travels through the internal passageway 80 to the internal passageway 76 of the injector body 74. The external passageway 84 is bounded by a collar 88 that is positioned around the nozzle 70 and is movable with the injector body 74. O-rings seals 90 are positioned between the collar 88 and the nozzle 70. The O-rings 90 are used to close the external passageway 84 when the collar 88 is in a first rearward position and to allow flow to travel through the external passageway 84 when the collar 88 is in a second forward position.

FIG. 15 shows the injector 28 in a high pressure spray position, where fluid only flows through the internal passageway 80 of the nozzle 70 and the nozzle tip 73. In this position, the collar 88 is positioned so that the O-rings 90 close the external passageway 84. The fluid exits through the nozzle tip 73 and passes through the venturi 82 defined in the internal passageway 76 of the injector body 74. The fluid passes through the venturi 82 at a pressure that creates a vacuum downstream of the nozzle 70 and allows suctioning of the second chemical from the second chemical tank 44 through the second chemical inlet 68, which is positioned downstream from the nozzle 70 in the injector body 74.

FIG. 16 shows the injector 28 in a low pressure spray position, where fluid flows both through the internal passageway 80 and through the external passageway 84 around the nozzle 70. In this embodiment, the collar 88 is positioned at a forward position so that the external passageway 84 is open. Flow enters the hole 86 in the nozzle 70 and exits around the nozzle 70, through the external passageway 84 until it joins with the internal passageway 76 of the injector body 74. This forward position of the collar 88 and injector body 74 represents the low pressure flow position, and chemical from the second chemical inlet 68 will not be introduced into the fluid because the vacuum required to suction the second chemical from the second chemical tank 44 is not present.

The injector 28 preferably includes a combination of metallic and non-metallic materials designed to deter corrosion of the metallic parts. The nozzle body 71, nozzle tip 73, and collar 88 are preferably made of a metallic material, such as brass, while the remainder of the injector 28 is preferably made of a non-corrosive material, such as thermoplastic. A preferred type of material is polypropylene. Because chemicals are often corrosive in nature, it is desirable to avoid bombarding the nozzle body 71 and nozzle tip 73 with a chemical during high pressure spray. For this reason, during high pressure spray, fluid alone travels from the pump 12 through the nozzle 70 because the first chemical will not be introduced into the flow stream since the venturi at the pump is designed for low pressure spray. In the high pressure spray mode, the second chemical is introduced downstream of any metallic parts, e.g., downstream from the nozzle 70 and the collar 88. In contrast, the first chemical combined with the fluid may travel through and around the nozzle 70 when in the low pressure mode since the metallic parts are designed to withstand a combination of fluid and chemicals at lower pressures. By utilizing a combination of metallic and plastic parts, and introducing the chemicals at different positions in the flow path depending on the pressure of the spray, the present invention assists in deterring the degradation of the nozzle 70 and provides substantially greater nozzle life with the added flexibility of being able to introduce chemicals to the flow stream at both high and low pressures of spray. Other types of metallic materials may be used for the nozzle 70 and collar 88. Alternate types of plastic materials may also be used for the cover 72 and body 74. Advances in the art may provide opportunities to utilize plastic materials for the nozzle 70 and collar 88.

FIGS. 15 and 16 also depict a check valve 92 that is positioned at the second chemical inlet 68. The check valve is utilized to prevent the back flow of fluid into the second chemical tank 44 during operation of the injector 28. In addition, O-ring seals 90 are positioned between the injector body 74 and the cover 72 and between the collar 88 and the injector body 74 in order to prevent fluid from flowing in undesirable directions. The spray lance 26 is preferably threaded to the nozzle 70 at the entrance of the injector 28 using conventional screw threads 62, although other types of attachment mechanisms may also be utilized.

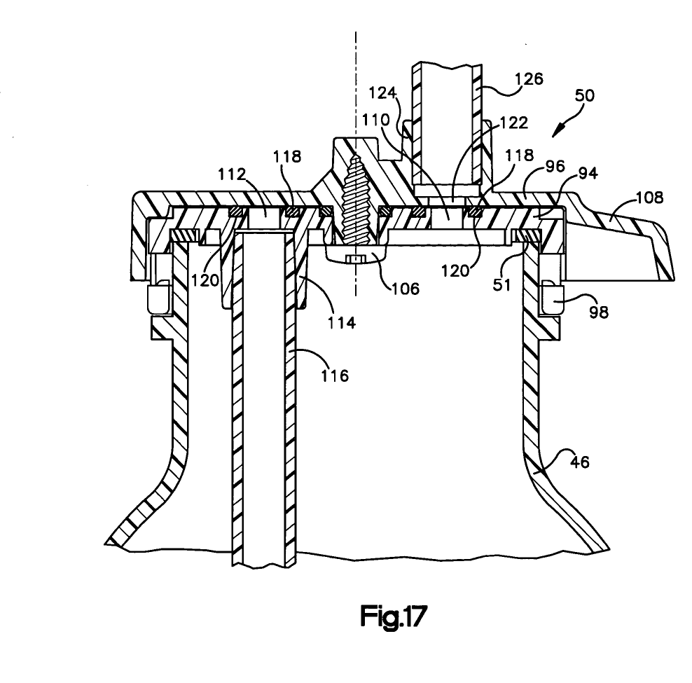

FIGS. 17-26 show the cap assembly 50 of the container 46. The cap assembly 50 is a multi-position selector valve for controlling chemical flow from the container 46 and includes an inner cap member 94 and an outer cap member 96. The outer cap member 96 is positioned adjacent to the inner cap member 94 and the inner cap member 94 abuts the opening 48 of the container 46.

The outer cap member 96 is movable relative to the inner cap member 94 in order to provide the cap assembly 50 with a number of operative positions. A first operative position is for use in the inverted position, e.g., when the injector 28 is pointed downward. A second operative position is for use in the upright position, e.g., when the injector 28 is pointed upwardly. A third position is an inoperative position, where the cap assembly 50 is closed so that no chemical can flow through the cap assembly 50 from the tank 44.

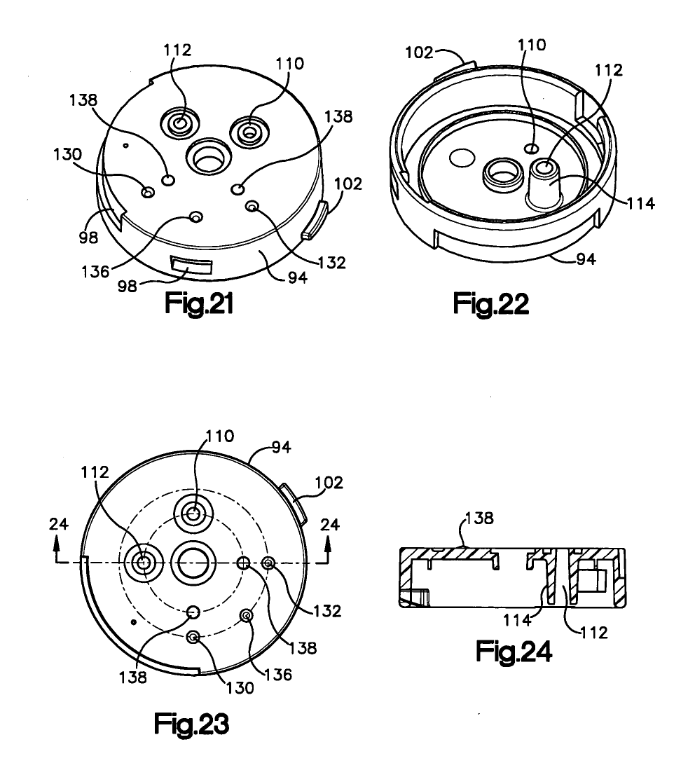

The inner cap member 94 includes an attachment mechanism 98, shown in FIGS. 21-24, for attaching the cap to the rim of the container 46. In a preferred embodiment, a quarter-turn bayonet mount with a snap lock is provided. Mating bayonet mount threads are provided on the inner cap member 94 and the rim of the container 46. The snap lock 100 is shown in FIG. 26 as including a prong 102 that extends outwardly from the side of the inner cap member 94 and a catch 104 that is positioned on and extends outwardly from the rim of the opening 48 of the container 46. The prong 102 and catch 104 are both made of a plastic material and, as such, have a resiliency that allows the prong 102 to lock the inner cap member 94 to the container 46, but, with sufficient application of force, allows the user to remove the cap assembly 50 from the container opening 48. Other known attachment mechanisms can also be used, such as conventional screw threads, among other known mechanisms. It is preferred that the selected attachment mechanism provide a water tight seal in order to avoid the unwanted discharge of chemical from the tank. In this regard, a seal 51 may be utilized between the inner cap member 94 and the rim of the container 46 if desired.

The outer cap member 96 is rotatably positioned on the inner cap member 94 and is retained on the inner cap member 94 by a screw 106, which is shown positioned near the center of the cap assembly 50 in FIG. 17. The outer cap member 96 includes a tab 108 that extends outwardly from the side of the cap assembly 50 and is configured so that a user may rotate the outer cap member 96 by moving the tab 108.

The inner cap member 94, as shown in FIGS. 17 and 21-24, includes a first opening 110 and a second opening 112. The first opening 110 is a hole that extends through the surface of the inner cap member 94 and is for use in the inverted position. When the user points the injector 28 downwardly, chemical in the tank 44 will flow through the first opening 110. The second opening 112 also is a hole that extends through the surface of the inner cap member 94, but the second opening 112 is surrounded by an inwardly extending flange or rim 114. This flange 114 is used to hold a section of tubing 116 that extends to the opposite end of the container 46 such that the tubing 116 is submerged in any chemical in the container 46. The tubing 116 may extend around the flange 114 or be inserted inside the flange to hold it in position. In a preferred embodiment, the tubing 116 is ¼ inch inside diameter plastic tubing. The flange 114 around the second opening 112 has a diameter sized to hold the plastic tubing 116 firmly in place. The second opening 112 is for the use of the container 46 in the upright position, and the tubing 116 preferably extends to the opposite end of the container 46 in order to suction out chemical when the container 46 is in an upright position. In addition, the second opening 112 may be used when the container 46 is in a horizontal position since the tubing 116, which has some flexibility, will sink to the bottom of the tank 44. Since the location of the bottom of the tank changes depending on the orientation of the tank 44, the tubing 116 should always be submerged in the chemical as long as the tank 44 is not inverted.

O-ring seals 118 are preferably positioned around each of the first and second openings 110, 112 and serve to provide a seal between the inner and outer cap members 94, 96. The O-rings 118 may be positioned in recesses 120 defined on the outer surface of the inner cap member 94, as shown in FIG. 17, or may be positioned in recesses defined on the inner surface of the outer cap member (not shown). The O-rings 118 may be made of a rubber material, such as buna-nitrile. The O-rings 118 preferably span any gap that is present between the inner and outer cap members 94, 96 in order to provide liquid-tight operation.

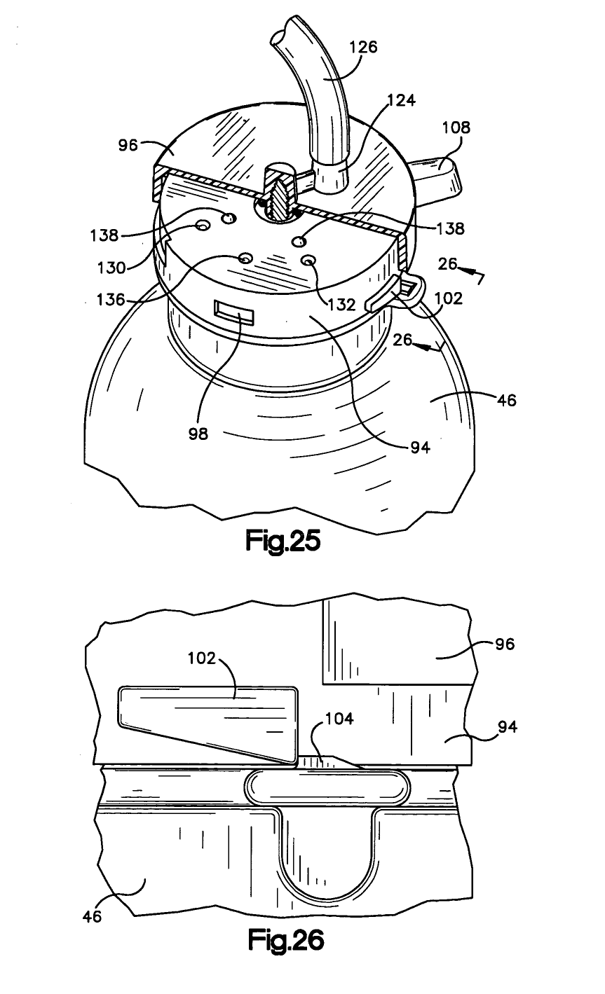

The outer cap member 96, as shown in FIGS. 17-20, has a third opening 122 that extends through the surface of the outer cap member 96. The outer cap member 96 includes an upstanding, outwardly facing flange or rim 124 that surrounds the third opening 122. This flange 124 is sized to accept a conduit or tube 126 that extends to the second chemical inlet 68 of the injector 28. Alternatively, the conduit can fit around the flange, as shown in FIG. 25. In a preferred embodiment, the conduit 126 is ¼ inch plastic tubing. In addition, the first, second, and third openings 110, 112, 122 may have a diameter that is about ⅛ inch, although this may vary depending upon the application and the size of the container 46.

The first, second, and third openings 110, 112, 122 are positioned so that when the outer cap member 96 is rotated relative to the inner cap member 94, the third opening 122 may align with the first opening 110 or the second opening 112 of the inner cap member 94. The first opening 110 aligns with the third opening 122 for inverted usage. The second opening 112 aligns with the third opening 122 for upright usage. The third opening 122 aligns with neither the first nor the second opening 110, 112 in the closed position.

The container 46 may include indicia 60 in the form of instructions to the user. For instance, the indicia 60 may align with the rotational positions of the outer cap member 96 to indicate “off”, “inverted”, or “upright” operation.

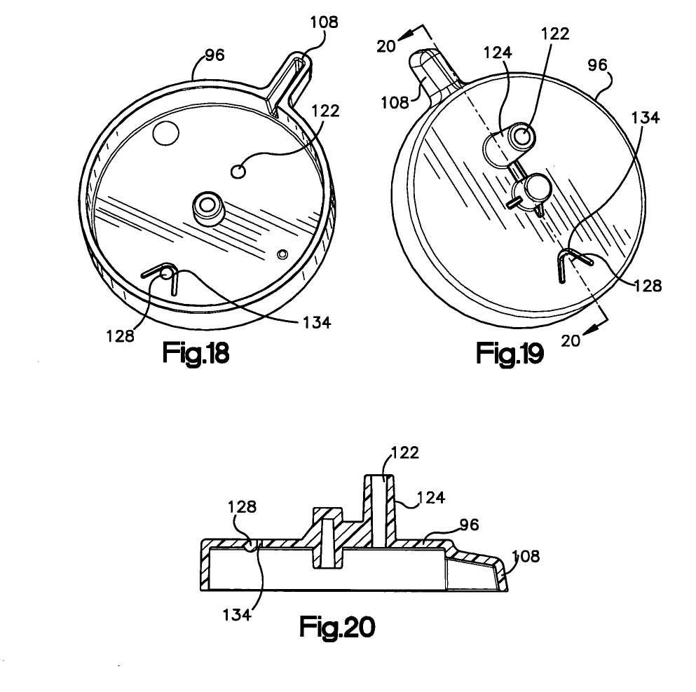

The outer cap member 96 is rotatable through a desired angular range in order to move between the three positions. For example, FIG. 17 shows one embodiment where the cap assembly 50 is rotatable through a 180° angular range. In this embodiment, the first and second openings 110, 112 are positioned 180° apart and the third, closed position is located between the first and second opening positions. In contrast, FIGS. 18-25 depict a cap assembly 50 that is rotatable through a 90° angular range. In FIGS. 18-25, the first and second openings 110, 112 are positioned 90° apart and the third, closed position is located between the first and second opening positions. Other ranges for angular rotation may also be used, if desired. For example, it is not necessary that the third, closed position be between the first and second opening positions. The third, closed position could be positioned outside the angular range of the first and second opening positions. For example, the third, closed position could be at 210° angular rotation, or another angular position.

The outer cap member 96 utilizes a detent system for informing the user that the proper position has been located for the angular rotation of the cap. The outer cap member 96 has a projection 128 for mating with recesses positioned on the inner cap member 94. The projection 128 aligns with a first recess 130 when the third opening 122 is aligned with the first opening 110 and with a second recess 132 when the third opening 122 is aligned with the second opening 112. The projection 128 aligns with a third recess 136 when the third opening 122 is not aligned with the first or second openings 110, 112 and is in a closed position. The combination of the projection 128 and recesses 130, 132, 136 provides a tactile message to the user when the third opening 122 is properly aligned with either the first or second openings 110, 112, or is in a closed position. As shown in FIGS. 18-20, the projection 128 may be defined on a V-shaped cut out 134 in the outer cap member 96 that forms a V-spring. In a preferred embodiment, the projection 128 is dome-shaped.

The inner cap member 94 also includes leveling bumps 138, which extend outwardly from the surface of the inner cap member 94 to abut the outer cap member 96. The leveling bumps 138 are positioned opposite the O-rings 118 around the first and second openings 110, 112. The leveling bumps are used to counteract the O-ring seals 118, which extend above the upper surface of the inner cap member 94 and are used to level the inner and outer cap members 94, 96 relative to one another. While the recesses 130, 132, 136 and leveling bumps 138 are shown positioned on the inner cap member 94 and the projection 128 is shown positioned on the outer cap member 96, they could be oppositely arranged, if so desired.

The inner and outer cap members 94, 96 are preferably made of a non-corrosive material, such as a thermoplastic. One type of thermoplastic that may be utilized is polypropylene.

It should be noted that while the first chemical tank is shown positioned on the cart next to the pump, the first chemical tank inlet can be positioned at any point in the flow path prior to the nozzle, as long as a venturi is positioned adjacent the first chemical inlet in the flow path. For instance, the first chemical inlet could be positioned on the spray wand upstream from the nozzle. The first chemical inlet could be positioned in the injector prior to the nozzle. The second chemical tank could be utilized for supplying a chemical at the first chemical inlet, as well as at the second chemical inlet. Appropriate valving would be necessary in order to distribute the chemical at either the first or the second chemical inlet in the low or high pressure spray mode. Thus, in this embodiment, which is not shown, a single chemical tank would be necessary to provide the three or four modes of operation of the pressure washer, as discussed above.

While various features of the claimed invention are presented above, it should be understood that the features may be used singly or in any combination thereof. Therefore, the claimed invention is not to be limited to only the specific embodiments depicted herein.

Further, it should be understood that variations and modifications may occur to those skilled in the art to which the claimed invention pertains. The embodiments described herein are exemplary of the claimed invention. The disclosure may enable those skilled in the art to make and use embodiments having alternative elements that likewise correspond to the elements of the invention recited in the claims. The intended scope of the invention may thus include other embodiments that do not differ or that insubstantially differ from the literal language of the claims. The scope of the present invention is accordingly defined as set forth in the appended claims.

1. A pressure washer comprising:
a pump having a fluid inlet for a fluid and a first chemical inlet for a first chemical, said pump being configured to selectively pump a fluid at a pressure that ranges from low to high, and to selectively pump a fluid combined with a first chemical in a low pressure range; and
an injector coupled to the pump, the injector having a nozzle and an external member, with the nozzle having an internal passageway and an external passageway, and the external member being positioned at least in part around the nozzle and the external passageway, the external member having a second chemical inlet positioned downstream from the nozzle for supplying a second chemical into a fluid, wherein the injector is configured to spray at least one of a fluid or a fluid and a first chemical in the low pressure range, and at least one of a fluid or a fluid and a second chemical in the high pressure range.

2. The pressure washer of claim 1, further comprising a spray lance coupled to the injector and a hose coupled between the pump and the spray lance, with the spray lance and the injector receiving a fluid or a fluid combined with a first chemical from the pump via the hose.

3. The pressure washer of claim 2, further comprising a first chemical housing coupled to the first chemical inlet and configured to house a first chemical, and a second chemical housing coupled to the second chemical inlet and configured to house a second chemical.

4. The pressure washer of claim 3, wherein the second chemical housing comprises a tank coupled to the spray lance and the first chemical housing comprises a tank coupled to the pump.

5. The pressure washer of claim 3, wherein the first chemical housing is coupled to a valve for opening the flow of a first chemical from the first chemical housing to the first chemical inlet, and the second chemical housing is coupled to a valve for opening the flow of a second chemical from the second chemical housing to the second chemical inlet.

6. The pressure washer of claim 3, wherein the pump and the first chemical housing are positioned on a cart, and further comprising a motor associated with the pump.

7. The pressure washer of claim 4, wherein the tank is coupled to the spray lance via at least one clip, such that the tank is integral with, but removable from the spray lance.

8. The pressure washer of claim 4, wherein the tank comprises an elongated, hollow member made of a non-corrosive material having an open end positioned in the vicinity of the injector, the open end being closed by a cap, with a conduit coupled to the cap for connecting the tank to the second chemical inlet of the injector.

9. The pressure washer of claim 8, wherein the cap comprises at least three operative positions, a first operative position where a second chemical is permitted to flow from the tank when the tank is in an inverted position, a second operative position where a second chemical is permitted to flow from the tank when the tank is in an upright position, and a third closed position where a second chemical is prevented from flowing through the cap.

10. The pressure washer of claim 8, further comprising a check valve associated with the conduit and the second chemical inlet of the injector.

11. The pressure washer of claim 2, further comprising a spray gun connected to the spray lance, with the spray gun having a trigger and a handle, the trigger being associated with a flow path of a fluid or a fluid combined with a first chemical from the pump and being operative to open and close the flow path.

12. The pressure washer of claim 1, wherein the external member is movable relative to the nozzle and includes a first operative position where the external passageway is closed and a second operative position where the external passageway is open, and a fluid or a fluid combined with a first chemical flow through both the internal passageway and the external passageway when the external member is in the second operative position.

13. The pressure washer of claim 1, wherein the external member includes a cover and an injector body, with the injector body being positioned inside the cover and the cover being rotatable relative to the injector body; and the nozzle further comprises a collar positioned between the injector body and the nozzle around the external passageway, with the collar being axially movable with the injector body and cover to open and close the external passageway.

14. The pressure washer of claim 13, wherein the external member further comprises a flow directing member positioned inside the external member and the cover is rotatable to change a spray pattern of a fluid from the injector by moving the flow directing member.

15. The pressure washer of claim 1, wherein the external member is made of a non-corrosive material and the nozzle is made of a metallic material.

16. The pressure washer of claim 1, further comprising a first venturi coupled to the pump upstream of the first chemical inlet, said first venturi for suctioning the first chemical into the fluid; and a second venturi positioned within the injector body upstream of the second chemical inlet, said second venturi for suctioning the second chemical into the fluid.

17. The pressure washer of claim 1, wherein the nozzle comprises a nozzle body and a nozzle tip coupled to the nozzle body, with the nozzle tip having a flow restricting portion.

18. The pressure washer of claim 1, wherein the low pressure range comprises pressures of about 25 to about 200 psi and the high pressure range comprises pressures of about 500 to about 3200 psi.

19. A pressure washer comprising:
a pump for pumping a fluid at at least a low pressure and a high pressure;
an injector coupled to the pump that has a restrictive nozzle for spraying the fluid; and
at least one chemical source for injecting a chemical into the fluid,
wherein the pressure washer has at least thee modes of operation, including a first mode comprising a low pressure spray of the fluid combined with the chemical, a second mode comprising a high pressure spray of the fluid, and a third mode comprising a high pressure spray of the fluid combined with the chemical, with the fluid flowing through the nozzle in the second and third modes and the fluid combined with the chemical flowing through and around the nozzle in the first mode.

20. The pressure washer of claim 19, further comprising a fourth mode of operation comprising a low pressure spray of the fluid, wherein the fluid flows through and around the nozzle in the fourth mode.

21. The pressure washer of claim 19, further comprising a spray lance coupled to the injector, and a hose coupled between the pump and the spray lance for transferring the fluid from the pump to the spray lance and injector, wherein the spray lance includes a flow through shaft.

22. The pressure washer of claim 21, wherein the at least one chemical source comprises a first chemical source associated with the pump and a second chemical source associated with the spray lance, wherein the first chemical source supplies a first chemical into the fluid during the first mode and the second chemical source supplies a second chemical into the fluid during the third mode.

23. The pressure washer of claim 19, wherein the low pressure fluid comprises a pressure range of about 25 to about 200 psi and the high pressure fluid comprises a pressure range of about 500 to about 3200 psi.

24. A pressure washer injector comprising:
a metallic nozzle having an axially extending internal passageway that includes a flow restricting portion, the nozzle for receiving a fluid under pressure from a pressure washer; and
a non-metallic external member positioned around at least part of the nozzle and including a chemical inlet and a venturi positioned upstream from the chemical inlet.

25. The pressure washer injector of claim 24, wherein the nozzle comprises a nozzle body coupled to a nozzle tip, with the nozzle tip including the flow restricting portion.

26. The pressure washer injector of claim 24, wherein the metallic nozzle is brass and the non-metallic external member is plastic, the external member is movable and rotatable relative to the nozzle, and the chemical inlet is positioned downstream from the nozzle.

27. The pressure washer injector of claim 24, wherein the external member comprises an injector body and a cover; and further comprising a collar positioned around the nozzle and movably associated with the injector body, with the collar defining an external flow passageway around the nozzle and the injector body being at least in part positioned between the cover and the collar.

28. The pressure washer injector of claim 26, wherein the injector body and the cover are movable axially, the cover is rotatable, and the collar is metallic.

29. The pressure washer injector of claim 26, further comprising a flow directing member positioned inside the cover and operable to change a spray pattern of the injector when the cover is rotated.

30. An injector comprising:
a metallic nozzle having an axially extending internal passageway, said internal passageway including a flow restricting portion; and
a non-metallic external member movably disposed around at least part of the nozzle and including a chemical inlet positioned downstream from the nozzle.

31. The injector of claim 30, wherein the nozzle comprises a nozzle body and a nozzle tip, with the nozzle tip including the flow restricting portion.

32. The injector of claim 30, further comprising a venturi defined in the external member positioned upstream from the chemical inlet.

33. The injector of claim 30, wherein the external member is configured to move axially relative to the nozzle between a high pressure position in which a fluid is forced through the internal passageway of the nozzle and a low pressure position in which a fluid is permitted to flow both through the internal passageway and around at least part of the nozzle.

34. The injector of claim 33, wherein the external member is rotatable in order to provide more than one spray pattern of the fluid flow.

35. The injector of claim 30, wherein the nozzle is brass and the external member is plastic.

36. The injector of claim 30, wherein the external member includes an injector body and a cover, with the injector body being positioned between the nozzle and the cover, and the cover disposed around the injector body; and
further comprising a collar positioned between the nozzle and the injector body, the collar being movable with the injector body and defining an external passageway around the nozzle.

37. The injector of claim 36, wherein the collar is metallic, the injector body and cover are movable axially, and the cover is rotatable.

38. The injector of claim 37, further comprising a flow directing member positioned inside the cover and operable to change a spray pattern of the injector when the cover is rotated.

39. An apparatus for a pressure washer comprising:
a spray lance having an injector; and
a container for containing a fluid attached to the spray lance.

40. The apparatus of claim 39, wherein the container is removably attached to the spray lance; the injector includes a chemical inlet and the container is fluidly coupled to the chemical inlet via a tube; the spray lance comprises an elongated wand, with the injector connected to one end of the elongated wand, and the container attached to the elongated wand adjacent the injector; and the container comprises at least one attachment mechanism configured to couple the container to the spray lance.

41. The apparatus of claim 40, wherein the at least one attachment mechanism comprises three clips, with two of the three clips facing in a direction opposite the other clip.

42. The apparatus of claim 40, wherein the at least one attachment mechanism comprises at least one clip, with each clip facing in a direction opposite of at least one of the other clips.
